(19) United States
(12) Patent Application Publication
(10) Pub. No.: US 2006/0247907 A1
(43) Pub. Date: Nov. 2, 2006

(54) Deciding assertions in programs with references

(75) Inventors: Shaz Qadeer, Seattle, WA (US); Sriram K. Rajamani, Bellevue, WA (US)

Correspondence Address: KLARQUIST SPARKMAN LLP, 121 S.W. SALMON STREET, SUITE 1600, PORTLAND, OR, 97204, US

(73) Assignee: Microsoft Corporation, Redmond, WA (US)

(21) Appl. No.: 11/117,800

(22) Filed: Apr. 29, 2005

(51) Int. Cl. G06F 9/45

(52) U.S. Cl. 703/22

(57) ABSTRACT

Described techniques and tools facilitate model checking for program models that effectively model pointer behavior while avoiding complexity in the model itself, thereby allowing rigorous and accurate testing of the model. A model checking algorithm for deciding assertions in programs with references terminates and yields precise results even on programs that allocate an unbounded amount of memory.

### FIELD

This application relates to testing and modeling of computer programs.

### BACKGROUND

In the field of computer software testing, different approaches have been developed to more accurately and completely test program function. For example, program modeling and model checking allow certain kinds of debugging analysis that may not otherwise be possible or practical in direct analysis of a program. Program models simplify certain aspects of programs to facilitate more complete testing of their overall behavior. Program models can be used to analyze programs as a whole, or, for larger programs, to analyze them one part at a time. When errors are found, changes can then be made to the program source code to correct the errors.

Most program models are limited in their overall coverage of program behavior and data types. For example, some program models are not able to effectively or efficiently model dynamic allocation of memory with references (or pointers). Pointers are program variables that refer to or “point to” another piece of data at a particular memory address. The “value” of the pointer itself is the address that it points to in memory. Assume that a pointer p* points to an integer value 5 stored at address “100” in memory. The value of the pointer p* itself is “100” and the value of the data it points to is 5. “Aliasing” occurs when more than one pointer points to the same piece of data. For example, if the pointer q* also points to the address “100” in memory, then q* is an alias of p*.

One kind of program modeling is Boolean abstraction. Boolean abstraction models the behavior of a program using Boolean predicates, which represent conditions in a program that can be evaluated as “true” or “false.” For example, the Boolean predicate (x>0) evaluates to “true” if the variable x has a positive value in a given program state, and evaluates to “false” otherwise. Predicates can be drawn from conditional statements and assertions in a program, or from other sources. Boolean abstraction can be done automatically using an automatic Boolean abstraction tool, with programmer analysis, or with some combination of tools and programmer analysis.

The product of a Boolean abstraction is referred to as Boolean program. A Boolean program includes a collection of Boolean predicates that can be analyzed by programmers or with testing applications, such as model checkers. A model checker is a testing application that performs testing on program models such as Boolean programs. Several different model checkers, including the BEBOP symbolic model checker for Boolean programs, are in use today. For more information on BEBOP and the SLAM static analysis project to which it relates, see Ball et al., “Bebop: A Symbolic Model Checker for Boolean Programs,” SPIN 00: SPIN Workshop, pp. 113-130 (2000), and Ball et al., “The SLAM Project: Debugging System Software Via Static Analysis,” POPL 02: ACM SIGPLAN-SIGA CT Symposium on Principles of Programming Languages, pp. 1-3 (January 2002)).

The SLAM project represented pointers with Boolean predicates. For example, for a pointer p*, the Boolean predicate (p*>5) evaluates to true when the value of the data pointed to by p* is greater than 5. However, there are some difficulties with this approach to modeling pointers. For example, it is sometimes difficult to definitively determine whether two pointers point to the same piece of data. Thus, the effects of aliasing are difficult to represent with Boolean predicates. Although refinements can be performed on Boolean abstractions to help them more accurately model behavior such as aliasing, such refinements introduce additional complexity to the model, which makes full testing of the model more difficult and costly.

Whatever the benefits of prior techniques, they do not have the advantages of the following techniques and tools.

### SUMMARY

In summary, techniques and tools for deciding assertions in programs with references are described.

Described techniques and tools facilitate model checking for program models that effectively model pointer behavior while avoiding complexity in the model itself, thereby allowing rigorous and accurate testing of the model. A model checking algorithm for deciding assertions in programs with references terminates and yields precise results even on programs that allocate an unbounded amount of memory.

The various techniques and tools can be used in combination or independently. Different embodiments implement one or more of the described techniques and tools.

Additional features and advantages will be made apparent from the following detailed description of different embodiments that proceeds with reference to the accompanying drawings.

### BRIEF DESCRIPTION OF THE DRAWINGS

FIG. 1 is a diagram showing a model checking system implementing techniques and tools for deciding assertions in programs with references.

FIG. 2 is a flow diagram showing a technique for generating a summary for a procedure based on a visible state and an effect on the visible state.

FIG. 3 is a flow diagram showing a technique for generating a summary for a procedure based on a pattern of a visible state and an effect on the visible state.

FIG. 4 is a flow diagram showing a technique for deciding assertions in a program comprising a Boolean program and non-recursive data types.

FIG. 5 is a code listing showing an example program capable of allocating potentially unbounded memory.

FIG. 6 is a table showing domains for a summarization algorithm in a detailed example.

FIG. 7 is a table showing a definition of an algorithm for procedure summarization for program with references in a detailed example.

FIG. 8 is a code listing showing a TraversalInfo declaration in a detailed example.

FIG. 9 is a code listing showing a top-level model checking algorithm implemented in a model checker in a detailed example.

FIGS. 10 and 11 are code listings showing helper functions for the algorithm in FIG. 9.

FIG. 12 is a table showing a comparison of model checking times with summarization and without summarization for a transaction management program in a detailed example.

FIG. 13 is a code listing showing a benchmark program for summarization in a detailed example.

FIG. 14 is a table showing a comparison of model checking times with summarization and without summarization for the benchmark program of FIG. 13.

FIG. 15 is a code listing showing an example program with concurrency and recursion.

FIG. 16 is a table showing a comparison of model checking times with summarization and without summarization for ZING regression tests in a detailed example.

FIG. 17 is a block diagram of a suitable computing environment for implementing described techniques and tools for deciding assertions in programs with references.

### DETAILED DESCRIPTION

Described implementations are directed to techniques and tools for deciding assertions in programs with references. Described techniques and tools facilitate model checking for program models that effectively model pointer behavior while avoiding complexity in the model itself, thereby allowing rigorous and accurate testing of the model.

A detailed example section describes a new model checking algorithm for deciding assertions in programs with references. The model checking algorithm terminates and yields precise results even on programs that allocate an unbounded amount of memory. This example also describes a general summarization algorithm (e.g., in a model checker) for programs that that have no restrictions on reference data types or concurrency.

Various alternatives to the implementations described herein are possible. For example, techniques described with reference to flowchart diagrams can be altered by changing the ordering of stages shown in the flowcharts, by repeating or omitting certain stages, etc. As another example, although some implementations are described with reference to specific abstraction methods, summarization methods, model checkers and/or algorithmic details, other abstraction methods, summarization methods, model checkers or variations on algorithmic details also can be used.

The various techniques and tools can be used in combination or independently. Different embodiments implement one or more of the described techniques and tools. Some techniques and tools described herein can be used in a model checker, or in some other system not specifically limited to model checking.

I. Techniques and Tools for Deciding Assertions in Programs with References

It is desirable for program models to be expressive enough to provide broad and detailed coverage of program behavior (or behavior of some part of a program) while remaining simple enough to be analyzed rigorously and completely (e.g. with a model checker). However, some program models are not able to effectively or efficiently model dynamic allocation of memory with references, and some model checking systems are not able to effectively and efficiently perform model checking on program models with references.

Accordingly, described techniques and tools include an algorithm for deciding assertions in programs with references. In program modeling, “assertion checking” involves determining whether the modeled behavior is consistent with the actual behavior of the program being modeled. An assertion checking problem for a particular type of model is “decidable” if the algorithm used to check the assertion on the model always terminates with the correct answer. Described techniques and tools include a model checking algorithm that terminates on certain kinds of program models with references and other non-recursive data types. Therefore, described techniques and tools are able to decide assertions in such programs.

In various implementations, described model checking techniques and tools allow Boolean programs to be extended with non-recursive references and other non-recursive data types. Boolean programs are products of Boolean abstraction that include a collection of Boolean predicates that can be analyzed by programmers or with testing applications, such as model checkers. Boolean abstraction models the behavior of a program using Boolean predicates, which represent conditions in a program that can be evaluated as “true” or “false.” For example, the Boolean predicate (x>0) evaluates to “true” if the variable x has a positive value in a given program state, and evaluates to “false” otherwise. Predicates can be drawn from conditional statements and assertions in a program, or from other sources. Boolean abstraction can be done automatically using an automatic Boolean abstraction tool, with programmer analysis, or with some combination of tools and programmer analysis.

A program state comprises the state of the program stack, global variables and the memory heap. Boolean programs can have recursive procedures and therefore have an infinite number of potential program states, because with recursive procedures, the stack can potentially be unbounded. Because it is not possible to test every program state, summarization is used to reduce the state space of a program to a finite set of states. A program state pair (s, s′) is a summary of a procedure P if, in program state s, there is an invocation of procedure P that yields the program state s′ on termination. If P is called from two different places with the same state s, the summary (s, s′) can be used to model the behavior of both calls of procedure P.

Pure Boolean programs do not have references. Therefore, assertion checking is decidable, even with a potentially unbounded call stack, when program state summaries are used. But for a model with a Boolean program and references (and, therefore, the potential for dynamic allocation of memory), the program state summaries described above do not make assertion checking decidable. This is because for programs with recursive procedures and pointers, the number of possible program state summaries is unbounded since the allocated addresses for pointers in a recursive procedure would be different with each procedure call.

Recall that the “value” of a pointer itself is the address that it points to in memory. Assume that pointer p*, a local variable within recursive procedure P, is newly allocated in P and points to address “100” in memory. P then recursively calls itself, and the next invocation of P allocates new memory at a different address, which is pointed to by a pointer (also labeled p*) that is local to this second invocation of P. The program containing the recursive procedure P has potentially unbounded memory allocation. Each new allocation changes the condition of the memory heap and therefore changes the program state. Therefore, a summary (s, s′) that measures only transitions from one program state to another program state will not make assertion checking decidable.

Visible State Summarization

Described techniques and tools enable deciding assertions in program models with references by using a different kind of procedure summary, which can be referred to as a visible state summary. A visible state summary of a procedure is a pair of (1) a visible state of the program; and (2) the effect that the procedure has on the visible state. A visible state is a state that is reachable from the procedure through the globals, locals, and formals in the current stack frame, and the subset of the heap that is reachable from the globals, locals, and formals. Thus, heap addresses that are only reachable from other stack frames (such as the caller of the current procedure) are not part of the visible state.

Although the number of visible states is unbounded (since the number of possible heap addresses is unbounded), an equivalence relation can be used to find visible states that are equivalent for the purposes of producing a procedure summary, thereby making the set of visible states a bounded set and making assertion checking decidable if all reference data types are non-recursive.

Described techniques and tools use the following equivalence relation: two visible states are equivalent if they differ only in the addresses of the heap cells and are indistinguishable in terms of aliasing. (A detailed example of such an equivalence relation is provided in detail below). With the use of such an equivalence relation, for any program comprising a Boolean program and non-recursive data types (also referred to as a BPNR program), the number of distinct non-equivalent visible states is finite, Therefore, the number of summaries is finite and assertion checking for BPNR programs is decidable.

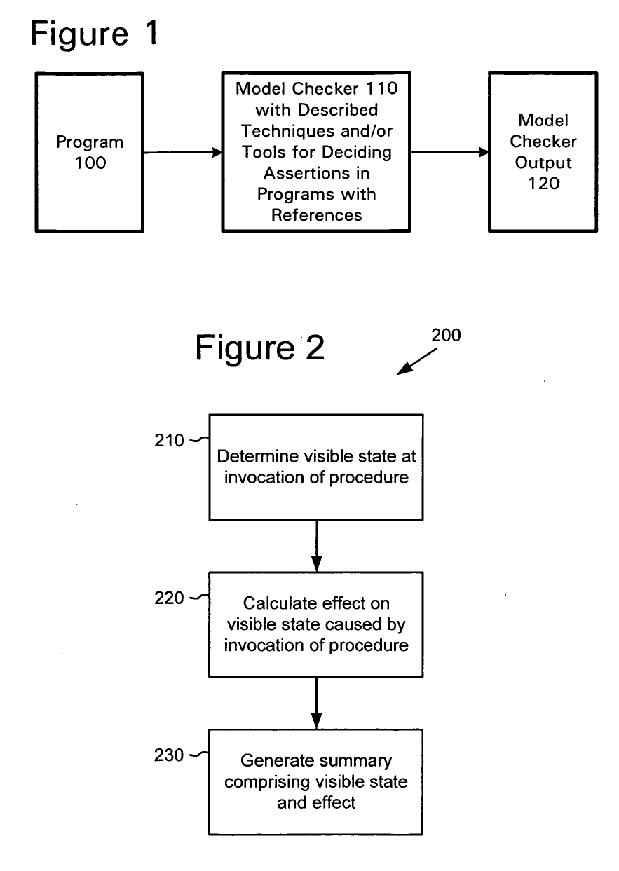

FIG. 1 shows a simplified system diagram for a model checking system with one or more of the described techniques and tools. For an input program 100 (e.g., a BPNR program comprising Boolean variables and references), a model checker 110 with described techniques and/or tools for deciding assertions in programs with references generates model checker output 120. Model checker output 120 can include, for example, error analysis, suggestions for resolving errors, model checking statistics, etc.

FIGS. 2, 3 and 4 show exemplary techniques in some implementations. The techniques can be performed, for example, using some combination of tools described herein or other available tools (e.g., program abstraction tools, model checking tools, etc.) and/or analysis (such as programmer analysis or automatic software analysis).

FIG. 2 is a flow chart showing a technique 200 for generating a summary for a procedure based on a visible state and an effect on the visible state. At 210, a visible state for a program is determined at invocation of a procedure. For example, the visible state is a state that is reachable from the procedure through the global variables and the locals and formals in the current stack frame, and the subset of the heap that is reachable from the globals, locals, and formals. Although in some implementations the visible state of a program includes globals, locals and formals, not all of these variables/parameters are required for a visible state. For example, in a program that does not use global variables, the visible state of the program need not include global variables. At 220, an effect (if any) on the visible state that is caused by the invocation of the procedure is calculated. Then, at 230, a summary for the procedure is generated. The summary comprises the visible state (immediately prior to invocation of the procedure) and the effect of the procedure on the visible state.

In some implementations, only part of the visible state of a program is used to generate a summary. For example, variables/parameters in a visible state that are actually observed by a procedure during its execution (and the subset of the heap that is reachable from those variables/parameters) can be used to generate a summary instead of the entire visible state. This part of a visible state can be referred to as a “pattern.” A pattern may omit, for example, one or more global variables that are part of a visible state but are not observed during execution of a procedure. Summaries can be generated for the procedure based on patterns and effects. An equivalence relation can be applied to patterns to determine which patterns are equivalent to one another. The number of non-equivalent patterns may be smaller than the number of non-equivalent visible states, thereby reducing the number of summaries for the procedure. For example, if two visible states differ in terms of the value of a global variable, those two visible states will be non-equivalent. However, two patterns in those visible states may be equivalent if the global variable is not observed by the procedure.

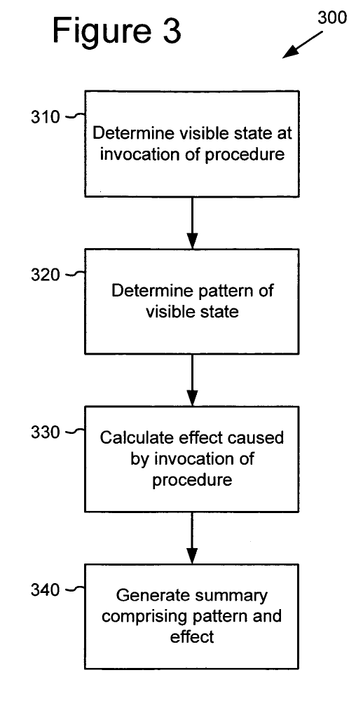

FIG. 3 is a flow chart showing a technique 300 for generating a summary for a procedure based on a pattern of a visible state and an effect on the visible state. At 310, a visible state for a program is determined at invocation of a procedure. At 320, a pattern of the visible state is determined. At 330, an effect (if any) on the visible state that is caused by the invocation of the procedure is calculated. Then, at 340, a summary for the procedure is generated. The summary comprises the pattern and the effect of the procedure on the visible state.

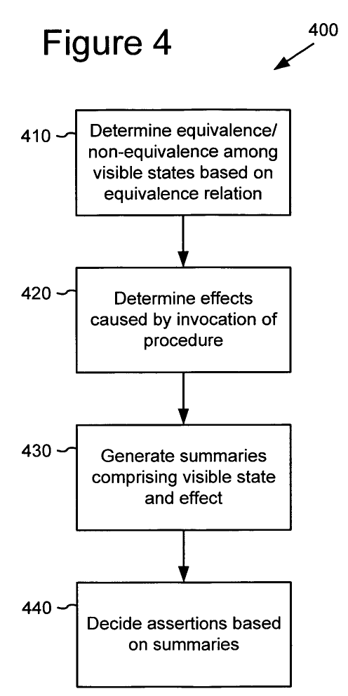

FIG. 4 is a flow chart showing a technique 400 for deciding assertions in a BPNR program (e.g., a BPNR model of a source code program) using an equivalence relation. At 410, for a procedure in the BPNR program, the model checker determines equivalence/non-equivalence among visible states based on an equivalence relation. Alternatively, the model checker determines equivalence/non-equivalence of patterns of visible states. At 420, the model checker determines effects on visible states caused by invocation of the procedure. At 430, the model checker generates one or more summaries for the procedure comprising pairs consisting of a visible state and an effect of the procedure on the visible state. Alternatively, the model checker generates one or more summaries for the procedure comprising pairs consisting of a pattern and an effect of the procedure on the visible state. At 440, the model checker decides assertions in the DPNR program model based on the summaries.

The assertion deciding process can be performed in other ways. For example, the model checker can decide assertions as each procedure is summarized, or can decide assertions for groups of procedures that have been summarized, or can decide assertions in some other way based on the summaries.

II. Detailed Example

The following detailed example describes an algorithm and implementation for deciding assertions in programs with references. The features and limitations described in this example vary in other implementations. For example, although this detailed example describes a specific implementation of a particular algorithm in a particular model checker, other implementations having different features are possible, and such implementations can be implemented in other kinds of model checkers.

A. Introduction

This detailed example presents a model checking algorithm for deciding assertions in programs with references. The model checking algorithm is precise, and terminates on programs with finite base types and non-recursive reference types. Non-recursive reference types do not imply a bound on the heap size. Therefore, the model checking algorithm terminates and yields precise results even on programs that allocate unbounded amount of memory, as long as the base types are finite and reference types are non-recursive. Thus, we can extend Boolean programs to include non-recursive references, and still use a model checker to decide assertions. This algorithm has been implemented in the ZING model checker, which supports a rich input language with references as well as concurrent threads. Even though termination is guaranteed only for programs with finite base types and non-recursive reference types, in practice, the algorithm terminates for several programs which do not satisfy these restrictions, and improves the performance of the model checker. The model checking algorithm improved the performance of the model checker by 30-35% on a concurrent transaction management program with 7000 lines of code, 57 dynamic allocation sites, and several million reachable states and found a subtle concurrency bug.

Boolean programs are programs in which all variables are Boolean. They have been used successfully as a target for representing automatically extracted models from C programs in the SLAM project. See Ball et al., “The SLAM Project: Debugging System Software Via Static Analysis,” POPL 02: ACM SIGPLAN-SIGACT Symposium on Principles of Programming Languages, pp. 1-3 (January 2002)). Boolean programs are infinite-state systems since they can have recursive procedures, and the stack depth is unbounded. Regardless, assertion checking is still decidable for Boolean programs. A common technique for analyzing such programs is CFL reachability (or equivalently, pushdown model checking, where the key idea is to build procedure summaries. See Esparza et al., “A BDD-based Model Checker for Recursive Programs,” CAV 01: Computer Aided Verification, pp. 324-336 (2001); Reps et al., “Precise Interprocedural Dataflow Analysis Via Graph Reachability,” POPL '95: ACM SIGPLAN-SIGACT Symposium on Principles of Programming Languages, pp. 49-61, San Francisco (January 1995); Sharir et al., “Two Approaches to Interprocedural Data Flow Analysis,” in Program Flow Analysis: Theory and Applications, pp. 189-233, Prentice Hall (1981); Steffen et al., “Composition, Decomposition and Model Checking of Pushdown Processes,” Nordic Journal of Computing, vol. 2, no. 2, pp. 89-125 (1995). The summary of a procedure P contains the state pair (s, s′) if in state s, there is an invocation of P that yields the state s′ on termination. Summaries enable reuse—if P is called from two different places with the same state s, the work done in analyzing the first call is reused for the second. This reuse is the key to scalability of interprocedural analyses. Additionally, summarization avoids direct representation of the call stack, and guarantees termination of the analysis even if the program has recursion.

In this detailed example, we extend Boolean programs with references and non-recursive data types, and assertion checking still remains decidable. This result is non-trivial since unbounded dynamic allocation of objects is allowed on the heap. Thus, programs in the extended language can have unbounded call stacks, and potentially can allocate unbounded memory. In spite of the possibility of such unbounded allocations, assertions can still be decided in such programs if all the reference data types are non-recursive.

A key insight is that even though the state of the heap in such a program is unbounded, for every invocation of a procedure, a summary can still be constructed that is a pair consisting of (1) the visible state that is reachable from the procedure through globals and the formal parameters, and (2) the effect that the procedure has on this visible state, which could involve changing some values and allocating new objects and linking them to the visible state. Even though the number of visible states can be still unbounded (since addresses are unbounded), an equivalence relation can be defined that relates “similar” visible states. The index of this equivalence relation is bounded if all reference data types are non-recursive, thereby yielding an algorithm to decide assertions in such programs.

The model checking algorithm can be thought of as extending precise inter-procedural reachability analysis (see Reps et al., “Precise Interprocedural Dataflow Analysis Via Graph Reachability,” POPL '95: ACM SIGPLAN-SIGACT Symposium on Principles of Programming Languages, San Francisco (January 1995)) to programs with non-recursive data types. Although concepts similar to those used in our paper have occurred in previous work on context-sensitive dataflow analysis, a core decision procedure useful for software model checking sets our work apart. In the compiler community, extensive work has been done in the area of pointer analysis. See Hind, “Pointer Analysis: Haven't We Solved This Problem Yet?” in ACM SIGPLAN/SIGSOFT Workshop on Program Analysis for Software Tools and Eng'g, pp. 54-61 (June 2001)). In particular, prior work on context-sensitive pointer analyses have investigated methods to do interprocedural pointer analysis using partial transfer functions (PTFs) (see Wilson et al., “Efficient Context-sensitive Pointer Analysis for C Programs,” SIGPLAN Notices, 30(6):1-12 (1995)). By cloning information at every calling context, and using Binary Decision Diagrams to represent the sharing between various contexts, context-sensitive pointer analyses have been recently made to scale on very large programs. See Whaley et al., “Cloning-based Context-sensitive Pointer Alias Analysis Using Binary Decision Diagrams,” PLDI '04: Proc. ACM SIGPLAN 2004 Conf. on Programming Language Design and Implementation, pp. 131-44, Washington, D.C. (June 2004). These analyses lose precision to enable scaling, and are mostly flow-insensitive.

For a model extracted from a large program, which captures only relevant variables and pointers that are of interest to prove a particular property, techniques and tools described herein can be used to decide assertions in this model without losing any precision. The model checking algorithm precisely decides assertions on possibly recursive programs with non-recursive data types, and unbounded number of allocations.

This result also has practical consequences. First, while doing automatic abstraction-refinement to model check software, we can make the target of the model extraction richer, and allow non-recursive data types, without losing decidability of the model checking phase. Since the relevant references are present in the extracted model, all aliasing queries are resolved with full precision on-the-fly during model checking. This feature of our analysis obviates the need for a coarse a priori pointer analysis while doing predicate abstraction. See Ball et al., “Automatic Predicate Abstraction of C Programs,” PLDI 01: Programming Language Design and Implementation, 203-213 (2001); Henzinger et al., “Lazy Abstraction,” POPL 02: ACM SIGPLAN-SIGACT Symposium on Principles of Programming Languages, pp. 58-70, Portland, Oreg. (January 2002). A number of iterations in the refinement loop are wasted in discovering extra aliasing predicates to regain the precision lost by the static pointer analysis. These iterations can be avoided, making the analysis much more efficient.

Second, the idea of using visible states and effects to summarize procedures which manipulate the heap, can be implemented even for programs with recursive data types and concurrent threads. Qadeer et al., “Summarizing Procedures in Concurrent Programs,” POPL '04: ACM SIGPLAN-SIGACT Symposium on Principles of Programming Languages, pp. 245-55, Venice, Italy (January 2004) (“the Qadeer paper”), uses the idea of transactions to build procedure summaries for concurrent programs. However, the work reported in the Qadeer paper does not deal with reference data-types, and no implementation was presented.

We have implemented a summarization algorithm in ZING, a software model checker being developed by Microsoft Corporation, for programs that have no restrictions on reference data types or concurrency. Though termination is guaranteed only when reference types are non-recursive, base types are finite domain, and recursive procedures are “transactional” as defined below in Section II.E, we find that the implementation terminates on several cases and outperforms the model checker without summarization.

The algorithm and implementation described in this detailed example can be used on programs that use recursive data types, but termination is not guaranteed for such programs. In practice, we find that the algorithm terminates on a number of programs that use recursive data types, for example, those that create bounded chains of objects. In these programs, summarization is still beneficial since it enables modular analysis of a program, one procedure at a time. A summary of a procedure deals only with the part of the state that is visible at that procedure, and enables scalable analysis. In experiments on a concurrent transaction management program, the model checker with summarization outperforms the model checker without summarization by 30-35%. The transaction management program has recursive data types, but does not have procedural recursion.

To summarize, this detailed example has two main ideas:

(1) We present a new model checking algorithm for deciding assertions in programs with references. Our algorithm terminates and yields precise results even on programs that allocate unbounded amount of memory, as long as the base types are finite and reference types are non-recursive.

(2) We describe an implementation of a general summarization algorithm in the ZING model checker, for programs that that have no restrictions on reference data types or concurrency. In this detailed example, we present details and experiments from the implementation described herein.

B. Overview (with Reference to Example Program)

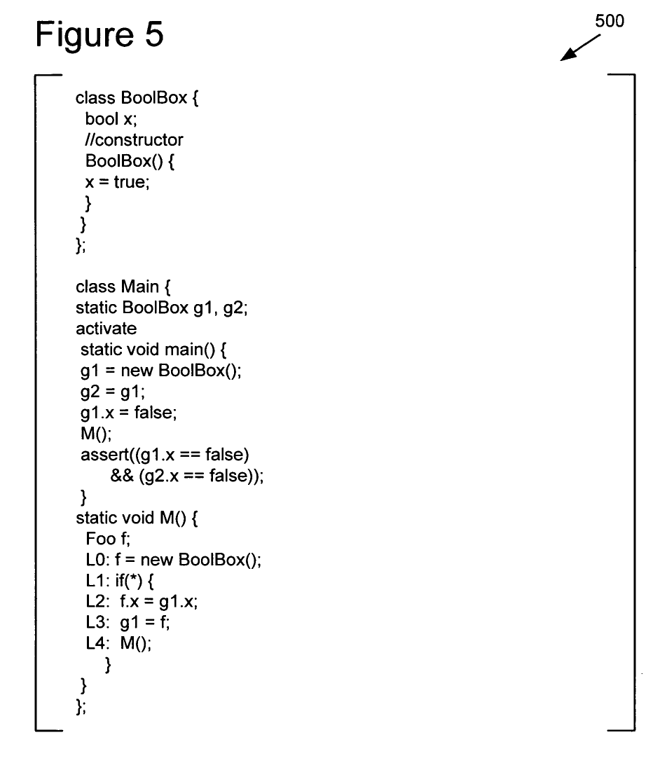

In this section, several main ideas of this detailed example are described with reference to the example program 500 shown in FIG. 5. Inside procedure “M,” at line L0, a new object is allocated and assigned to local variable “f.” Then, a nondeterministic choice is made at line L1. In one of the choices “f.x” is assigned the value of “g1.x” and then the global “g1” is made to point to the local object created at line L0 and pointed-to by “f.” This is followed by a recursive call to “M.” The other choice just terminates “M” and returns. This program 500 can allocate an unbounded amount of memory since there is an execution that always chooses to take the “if” branch of the nondeterministic choice at line L1 and ends up creating an unbounded stack, and allocating an unbounded number of objects each pointed-to by a local variable from a stack frame.

The state of a program contains the globals, the stack and the heap. To do modular analysis of a program, it is useful to consider the notion of visible state of a program with respect to a particular invocation of a procedure (i.e., a stack frame). The visible state of a program consists of the locals, formals, globals in the current stack frame and the subset of the heap that is reachable from the locals, formals and globals. Thus, heap addresses that are only reachable from other stack frames such as the caller, or the caller's caller, are not part of the visible state (though they are part of the state of the program).

Consider the invocation of “M” in procedure “main” from the example. The visible state S₁ of “M” at this invocation consists of “g1,” “g2” and the single heap cell that they both point to, which is of type “BoolBox” and has its “x” field set to false. Let us call the address of the heap cell as A0. We will represent visible states by a set of address-value pairs. For example, the visible state described above is represented by: S₁={(g1,A0), (g2,A0), ( [symbol] A0,x [symbol] ,false)}.

Two visible states are “equivalent” if they differ in only the actual address of the heap cells, and are indistinguishable otherwise, in terms of aliasing or values of base-types in the state. For example, consider the visible state S2={(g1,A1), (g2,A1), ( [symbol] A2,x [symbol] ,false)}. Then, S1 and S2 are equivalent. However, the visible state S₃={(g1,A0), (g2,A2), ( [symbol] (A0,x [symbol] ,false), ( [symbol] (A2,x [symbol] ,false)} is not equivalent to S₁ since the aliasing relationship between “g1” and “g2” is different in S₁ and S₃.

Even though the number of heap cells allocated by a program could be unbounded, the number of non-equivalent visible states for a procedure invocation has to be finite if the base types are Boolean and reference types are non-recursive. This notion is made more precise below, and is crucial for our termination theorem (Theorem 3, below). For example, if we consider all the (unbounded number of) invocation contexts of procedure “M” in FIG. 5, every visible state is equivalent to either S₁ or S₃ —the visible state is equivalent to S₁ for the call made to “M” from “main,” and the visible state is equivalent to S₃ for each of the unbounded number of recursive calls made to “M” at line L4.

An “effect” is a function from visible states to visible states. A “summary” of a procedure P is a state pair (S, e), where S is a visible state and e is an effect. Intuitively, e(S) represents a possible visible state at termination of procedure P if the procedure is invoked at visible state S. More concretely, an effect e is represented as a pair (as, m) where as is a set of addresses that represent object allocations, and m is a set of updates. In order to apply an effect e=(as, m) on a state S, one first allocates objects at addresses from as in S and performs the updates prescribed by m.

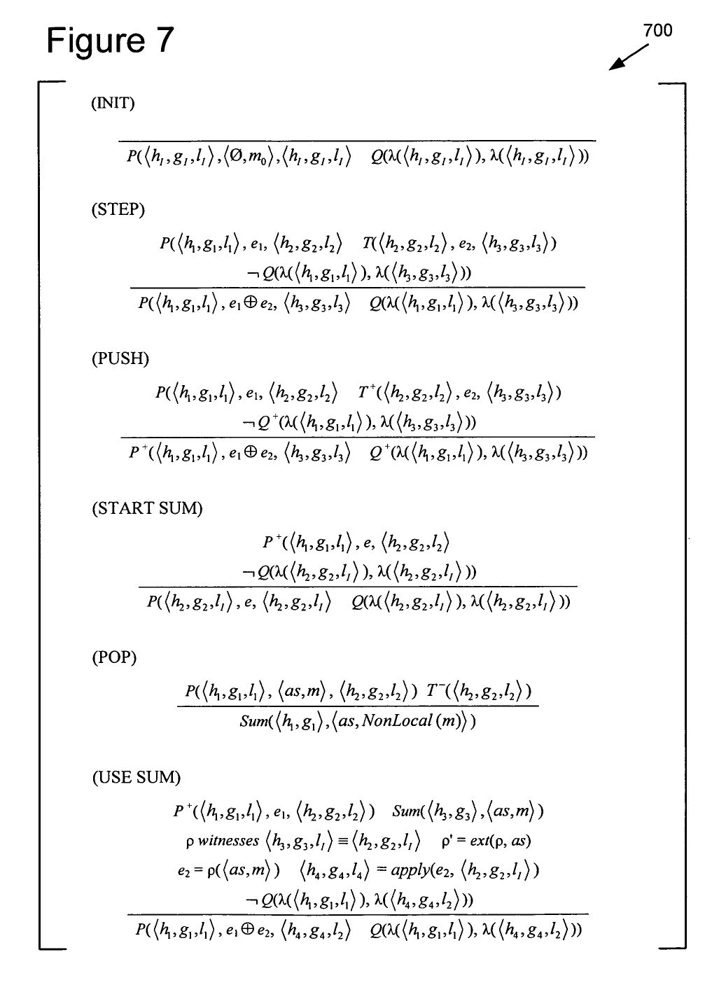

For example, if “M” is invoked at visible state S₁={(g1,A0), (g2,A0), ( [symbol] A0,x [symbol] ,false)}, the procedure “M” can have three different behaviors: (1) it can generate an empty effect e₁=({ },{ }), which represents the case where the “if” branch is not taken, and the final visible state at the exit of procedure “M” is the same as the visible state on entry, or (2) it can generate a effect e₂=({A1},{(g1,A1), ( [symbol] A1, x [symbol] ,false)}), where A1 is the address of a newly allocated object, and the pair (g1,A1) denotes that “g1” is updated to hold the value A1, and the pair ( [symbol] A1,x [symbol] ,false) denotes the value of the “BoolBox” object at address A1, or (3) it can enter an infinite recursion and never return. In this detailed example, summaries are not generated for non-terminating executions since we are checking for safety properties only. (But alternatively, other properties can be checked.) Thus, for the visible state S₁ we have two summaries for procedure “M,” namely {(S₁, e₁), (S₂, e₂)}. The algorithm 700 in FIG. 7, which is described in further detail below, shows how these two summaries (and only these two summaries) are computed for “M.”

An invocation to “M” at S₃={(g1,A0), (g2,A2), ( [symbol] A0,x [symbol] ,false), ( [symbol] A2,x [symbol] ,false)} also can generate the same three behaviors as the ones for S₁. Thus the summaries of “M” are given by the finite set: {(S₁, e₁), (S₁, e₂), (S₃, e₁), (S₃, e₂)}. Since any invocation to “M” happens at a visible state equivalent to either S₁ or S₃, these summaries can be used to generate all possible visible states at the exit of “M”, without descending into the body of “M.” Applying the effects of these summaries lets us decide that the assertion after the call to “M” in “main” can never get violated.

Often, a procedure does not make use of its entire visible state during its execution. In such cases, it is useful to generalize the notion of visible state to a “pattern,” which is the subset of the visible state that is actually observed by the procedure “M” during its execution. For example, in procedure “M” from FIG. 5 the value of the global variable “g2” is never observed by procedure “M.” Thus, the portion of the visible state S₁ that is observed by “M” is given by P₁={(g1,A0), ( [symbol] A0, x [symbol] ,false)}. Similarly, the portion of the visible state S₃ that is observed by “M” is given by P₃={(g1,A0), ( [symbol] A0,x [symbol] ,false)}. Even though the visible states S₁ and S₃ are not equivalent, the patterns P₁ and P₃ are equivalent. Thus, the same set of behaviors will be generated by executing “M” from these two visible states. We therefore generalize a summary to be a pair (P,E) where P is a pattern over a visible state and E is a set of effects. With this generalization, the procedure “M” in our example has summaries {(P₁,{e₁, e₂})}. By using this generalization, we were able to generate fewer summaries, and increase the re-use of the generated summaries.

C. Definitions for Detailed Example

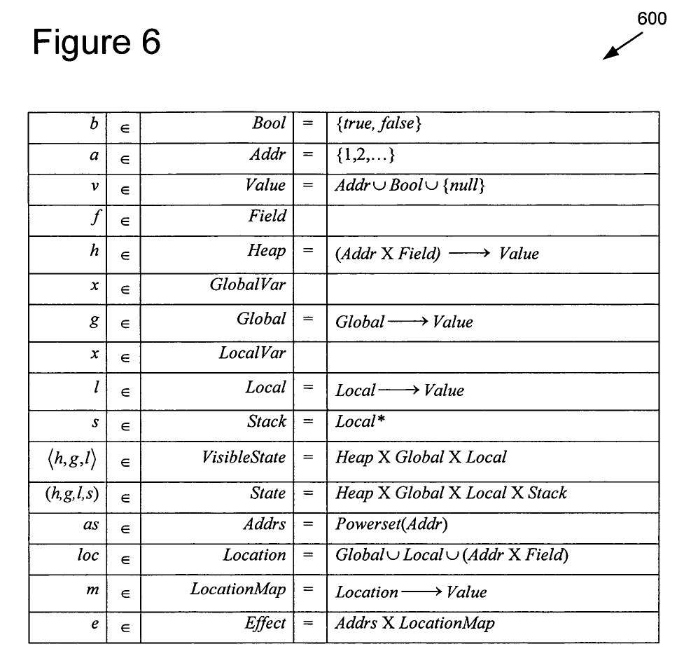

This section introduces a formalization of a sequential program as a state transition system. Domains referred to in this section are shown in table 600 in FIG. 6, and are explained in detail below.

A state of a sequential program has four components: a heap h, a global store g, a local store l, and a stack s. The heap h is a collection of cells, each of which has a unique address and contains a finite set of fields. Formally, the heap h is a partial map from pairs containing an address and a field to values. Given address a and field f, the value stored in the field f of cell with address a is h(a,f). The global store g is a valuation to global variables, the local store l is a valuation to local variables, and the stack s is a sequence of local stores. A variable or a field of a cell is called a location. Each location has a unique type, either Boolean or reference. A location of Boolean type contains a Boolean value. A location of reference type contains either null or the address of a cell.

A sequential program starts execution in the state (hₗ, gₗ, lₗ, ε), where hₗ is the initial empty heap, gₗ is the initial global store, lₗ is the initial local store, and ε is the initial empty stack. Our formalization of the program state is different from the standard formalization in which lₗ would be considered the top of the stack. When the program makes a transition, its state is updated according to an effect. An effect [symbol] as, m [symbol] is a pair containing a set of addresses as and a map m from locations to values. The set as gives the addresses of the cells allocated during the transition and the map m provides the new values for the subset of locations updated by the transition. A sequential program is a tuple [symbol] T,T⁺,T⁻ [symbol] of three relations:
T⊂(Heap×Global×Local)×Effect×(Heap×Global×Local)
T⁺⊂(Heap×Global×Local)×Effect×(Heap×Global×Local)
T⁻⊂(Heap×Global×Local)

The relation T models steps that do not manipulate the stack. The relation T( [symbol] h,g,l [symbol] , e, [symbol] h′,g′,l′ [symbol] ) holds if the program can take a step from a state with heap h, global store g and local store l, yielding (possibly modified) heap h′, global store g′, and local store l′. The stack is not accessed or updated during this step. The relation T⁺( [symbol] h,g,l [symbol] , e, [symbol] h′,g′,l′ [symbol] ) models a procedure call. The heap, global store, and local store are initially h, g and l respectively. After the step, the heap is modified to h′, the global store is modified to g′, the local store l′ is pushed onto the stack, and the called procedure starts execution in local store lₗ. Similarly, the relation T⁻(h, g, l) models a procedure return. The heap, global store, and local store are initially h, g and l respectively. After the step, the heap and global store are unmodified, and the local store is modified to the local store popped from the stack.

The transition relation → of the program is formally defined as follows:

$$( STEP )$$

$$\frac{T ( 〈 h , g , l 〉 , ⅇ , 〈 {h}^{′} , {g}^{′} , {l}^{′} 〉 )}{( h , g , l , s ) \to ( {h}^{′} , {g}^{′} , {l}^{′} , s )}$$

$$( PUSH )$$

$$\frac{{T}^{+} ( 〈 h , g , l 〉 , ⅇ , 〈 {h}^{′} , {g}^{′} , {l}^{′} 〉 )}{( h , g , l , s ) \to ( {h}^{′} , {g}^{′} , {l}_{I} , s \cdot {l}^{′} )}$$

$$( POP )$$

$$\frac{{T}^{-} ( 〈 h , g , l 〉 )}{( h , g , l , s \cdot {l}^{′} ) \to ( h , g , {l}^{′} , s )}$$

We require every heap h to satisfy the following consistency property for all addresses a and a′ and fields f and f′: if h(a,f) is an address a′, then h(a′,f′) is defined.

For each triple [symbol] h,g,l [symbol] , let Cells( [symbol] h,g,l [symbol] ) be the set of addresses of reachable cells. Formally, Cells( [symbol] h,g,l [symbol] ) is the least set of addresses satisfying the following conditions: (1) if g(x)εAddr, then g(x)εCells( [symbol] h,g,l [symbol] ); (2) if l(x)εAddr, then l(x)εCells( [symbol] h,g,l [symbol] ); (3) if fεField, aεCells( [symbol] h,g,l [symbol] ), and h(a,f)εAddr, then h(a,f)εCells( [symbol] h,g,l [symbol] ). A “visible state” is a triple [symbol] h,g,l [symbol] such that Cells( [symbol] h,g,l [symbol] )=dom(h).

A partial function ρ: Value→Value is a “permutation” if it satisfies the following properties: (1) if vεBool, then ρ(v)=v; (2) ρ(null)=null; (3) ρ restricted to Addr is a partial one-one map from Addr to Addr. Two visible states [symbol] h₁,g₁,l₁ [symbol] and [symbol] h₂,g₂,l₂ [symbol] are “equivalent” (written [symbol] h₁,g₁,l₁ [symbol] ≡ [symbol] h₂,g₂,l₂ [symbol] ) if there exists a permutation ρ such that the following hold: (1) g₂(x)=ρ(gₗ(x)) for all xεGlobalVar; (2) l₂(x)=ρ(lₗ(x)) for all xεLocalVar; (3) h₂(ρ(a),f)=ρ(h₁(a,f)) for all aεCells( [symbol] h₁, g₁,l₁ [symbol] and fεField. The function ρ is called a witness for the equivalence of [symbol] h₁,g₁,l₁ [symbol] and [symbol] h₂,g₂,l₂ [symbol] . The relation ≡ partitions the set of visible states into a set of equivalence classes. Let λ be a function that maps each visible state [symbol] h,g,l [symbol] to a unique representative in its equivalence class. We call λ the “canonizing function” for the sequential program.

Suppose ρ is a permutation. Given a set of addresses as, we define ρ(as)={ρ(a) |aεas}. Given a location map m, we define the location map ρ(m) as follows:

| | | |
|---|---|---|
| ρ(m)(x) | = ρ(m(x)), | if x ∈ GlobalVar |
| ρ(m)(x) | = ρ(m(x)), | if x ∈ LocalVar |
| ρ(m)(ρ(a), f) | = ρ(m(a, f)), | if a ∈ Addr and f ∈ Field |

Given an effect [symbol] as, m [symbol] , we define ρ( [symbol] as,m [symbol] )= [symbol] ρ(as),ρ(m) [symbol] .

D. Algorithm

In this section, an algorithm 700 for procedure summarization in the presence of references is described with reference to FIG. 7. To specify this algorithm, we first need to define a few simple operations.

Consider an effect [symbol] as,m [symbol] and a visible state [symbol] h,g,l [symbol] . If as ∩ dom(h)=Ø (the empty set), then [symbol] as,m [symbol] is applied to [symbol] h,g,l [symbol] by performing the following operations in sequence: (1) extend h so that for all aεas and field fεField, if f has type Boolean, then h(a,f)=false, otherwise h(a,f)=null; (2) for each global variable x such that m(x) is defined, update g(x)=m(x); (3) for each local variable x such that m(x) is defined, update l(x)=m(x); (4) for each address a and field f such that m(a,f) is defined, update h(a,f)=m(a,f). Let apply( [symbol] as,m [symbol] , [symbol] h,g,l [symbol] ) denote the visible state that results from applying the effect [symbol] as,m [symbol] on the visible state [symbol] h,g,l [symbol] .

Suppose ρ is a witness for the equivalence of [symbol] h₁,g₁,l₁ [symbol] and [symbol] h₂,g₂,l₂ [symbol] and [symbol] as,m [symbol] an effect such that as ∩ Cells( [symbol] h₁,g₁,l₁ [symbol] )=Ø. Then, it is clearly possible to extend ρ so that it maps Cells( [symbol] h₁,g₁,l₁ [symbol] )∩as) one-one into Addr. Let ext(ρ,as) denote a particular such extension of ρ.

We define the composition m₁⊕m₂ of two location maps m₁ and m₂. Formally, for all loc, let m₁⊕m₂(loc) be m₂(loc) if m₂(loc) is defined, and m₁(loc) otherwise. Also, let [symbol] as₁,m₁ [symbol] ⊕ [symbol] as₂,m₂ [symbol] = [symbol] as₁∪as₂, ms₁⊕m₂). Finally, let NonLocal(m) be the restriction of the map m to Global ∪ (Addr X Field).

Our algorithm performs a fixpoint computation over the following relations:
P⊂(Heap×Global×Local)×Effect×(Heap×Global×Local)
P⁺⊂(Heap×Global×Local)×Effect×(Heap×Global×Local)
Sum⊂(Heap×Global)×Effect
Q⊂(Heap×Global×Local)×(Heap×Global×Local)
Q⁺⊂(Heap×Global×Local)×(Heap×Global×Local)

The relation P is analogous to the set of “path edges” in interprocedural dataflow analyses. The relation P⁺ denotes those path edges that end in a procedure call. The relation Sum is analogous to the set of “summary edges.” For more information, see Reps et al., “Precise Interprocedural Dataflow Analysis Via Graph Reachability,” POPL '95: ACM SIGPLAN-SIGACT Symposium on Principles ofprogramming Languages, San Francisco (January 1995). Finally, the relations Q and Q⁺ contain canonized representations of the edges in P and P⁺ respectively. These last two relations are crucial for the termination of the algorithm.

Our algorithm is specified as a set of rules for performing a fixpoint computation over the relations mentioned above. To ensure that the fixpoint terminates, we also compute the canonical representative of each new edge generated by the algorithm. Whenever a new edge [symbol] h,g,l [symbol] , [symbol] h′, g′,l′ [symbol] is added to P, its canonical representative (λ( [symbol] h,g,l [symbol] ), λ( [symbol] h′,g′,l′ [symbol] )) is added to Q. Similarly, whenever a new edge [symbol] h, g, l [symbol] , [symbol] h′,g′,l′ [symbol] is added to P⁺, its canonical representative (λ( [symbol] h,g,l [symbol] ), λ( [symbol] h′,g′,l′ [symbol] )) is added to Q⁺.

Recall that h₁ is the initial heap, g₁ is the initial global store and l₁ is the initial local store. Referring again to FIG. 7, the fixpoint computation is kicked off by an application of the first rule (INIT) in algorithm 700, which adds the edge ( [symbol] h₁,g₁,l₁ [symbol] , [symbol] Ø,m₀ [symbol] , [symbol] h₁,g₁,l₁ [symbol] ) to P, where m₀ is the empty location map undefined at all locations. The rule “(STEP)” extends an edge in P by exploring a transition. The new edge generated is added to P only if its canonical representative is not already present in Q. The rule “(PUSH)” is similar to the rule “(STEP)” and generates an edge in P⁺ if the canonical representative of that edge is not present in Q+. The rule “(START SUM)” starts off a fresh summary computation in the called procedure. The rule “(POP)” creates a procedure summary edge in Sum. This edge consists of a pair [symbol] h, g [symbol] comprising the initial heap and global store, and an effect [symbol] as, m [symbol] that describes the updates to the global variables and the heap. The updates to local variables in are filtered out by applying the function NonLocal because the summary edge is used only at the call site which has its own copy of the local variables. The rule “(USE SUM)” is the most complicated rule and deals with the application of a summary edge in Sum at a call site. A summary edge is applicable if the heap and global store at its source is equivalent to the heap and global store at the call site. Suppose ρ is the witness to the equivalence. We first extend ρ so that it maps the addresses of the new cells created in the summary edge appropriately. Then, we create a new effect e₂ obtained by applying ρ to the effect in the summary edge. Finally, the new state is obtained by applying e₂ to the state at the call site.

The following theorems establish correctness of the algorithm:
Theorem 1 (Soundness): If (h₁,g₁,l₁,ε)→*(h, g, l, s), then there exist [symbol] h′,g′,l′ [symbol] , h₁, and g₁ such that [symbol] h′,g′,l′ [symbol] ≡ [symbol] h,g,l [symbol] and P( [symbol] h₁,g₁,l₁ [symbol] , [symbol] h′,g′,l′ [symbol] ).
Theorem 2 (Completeness): If P( [symbol] h₁,g₁,l₁ [symbol] , [symbol] h′,g′,l′ [symbol] ), then there exist [symbol] h,g,l [symbol] and s such that [symbol] h,g,l [symbol] ≡ [symbol] h′,g′,l′ [symbol] and (h₁,g₁,l₁,ε)→*(h, g, l, s).

We now present the argument for the termination of our algorithm. This argument requires the notion of k-boundedness for some non-negative number k. A visible state [symbol] h,g,l [symbol] is k-bounded if the longest chain of references starting from a global or a local variable has length at most k. Although the set of k-bounded visible states is unbounded, this unbounded set is partitioned into a finite set of equivalence classes by the relation ≡. This observation forms the crux of the argument for the termination of our algorithm.

A sequential program [symbol] T,T⁺,T⁻ [symbol] is k-bounded if the following conditions hold:
If T( [symbol] h,g,l [symbol] , e, [symbol] h,g,l [symbol] ), then [symbol] h,g,l [symbol] and [symbol] h′,g′,l′ [symbol] are k-bounded.
If T⁺( [symbol] h,g,l [symbol] , e, [symbol] h,g,l [symbol] ), then [symbol] h,g,l [symbol] and [symbol] h′,g′,l′ [symbol] are k-bounded.
If T⁻( [symbol] h,g,l [symbol] ), then [symbol] h,g,l [symbol] is k-bounded.

Consider a sequential program all of whose base types have finite domains and all of whose reference types are non-recursive. It is easy to show that such a program is k-bounded for some finite number k that can be determined from the static type structure of the program. We can now state our termination theorem.
Theorem 3 (Termination): If the sequential program [symbol] T, T⁺, T⁻ [symbol] is k-bounded, then the fixpoint computation specified by the rules described above terminates.

E. Implementation

The summarization algorithm described in this detailed example was implemented in Microsoft Corporation's ZING model checker. The implementation in the ZING model checker is more general than the description from Section II.D, above, in two ways: (1) it works on the entire ZING language, with both integer and Boolean base types, and with reference types not restricted to be non-recursive; and (2) it also handles concurrent programs in a sound manner using transactions, and the idea of summarizing within a transaction, a technique described in Qadeer et al., “Summarizing Procedures in Concurrent Programs,” POPL '04: ACM SIGPLAN-SIGACT Symposium on Principles of Programming Languages, pp. 245-55, Venice, Italy (January 2004).

Transactions can be described using examples from programs that use mutexes to protect accesses to shared variables. The action acquire(m), where m is a mutex, is a right mover. Once the action happens, there is no enabled action of another thread that may access m. Hence, this action can be commuted to the right of any action of another thread. The action release(m) is a left mover. At a point when this action is enabled but has not happened, there is no enabled action of another thread that may access m. Hence, this action can be commuted to the left of any action of another thread. An action that accesses only local variables is both a left mover and a right mover, since this action can be commuted both to the left and the right of actions by the other threads. An action that accesses a shared variable is both a left mover and right mover, as long as all threads acquire the same mutex before accessing that variable.

A “transaction” is a sequence of right movers, followed by a single atomic action with no restrictions, followed by a sequence of left movers. A transaction can be in two states: pre-commit or postcommit. A transactions starts in the pre-commit state and stays in the pre-commit state as long as right movers are being executed. When the atomic action (with no restrictions) is executed, the transaction moves to the post-commit state. This atomic action is called the committing action. The transaction stays in the post-commit state as long as left movers are being executed until the transaction completes.

Termination of the model checking algorithm is guaranteed if base types are Boolean, and reference types are non-recursive, and it is either the case that the program is sequential (due to Theorem 1, above), or it is the case that the program is concurrent, and every recursive function call is transactional.

The ZING compiler compiles the ZING program into a Microsoft Intermediate Language (“MSIL”) object code called ZING Object Model (“ZOM”). The object code supports a specific interface intended to be used by the model checker. The ZOM assembly has an object of type State which has a stack for each process, a global storage area of static class variables, and a heap for dynamically allocated objects. Several aspects of managing the internals of the State object can be done generically, for all ZING models. This common state management functionality is factored into a ZING runtime library.

First, we sketch how the top-level state space exploration is implemented in the ZING model checker. The ZING model checker uses Depth First Search (DFS), with incremental state-cloning, and a fingerprinting algorithm that canonicalizes heaps so that equivalent states map to identical fingerprints. For more information, see Andrews et al., “Exploiting Program Structure for Model Checking Concurrent Software,” CONCUR 2004: 15th Int'l Conf. on Concurrency Theory, London (September 2004).

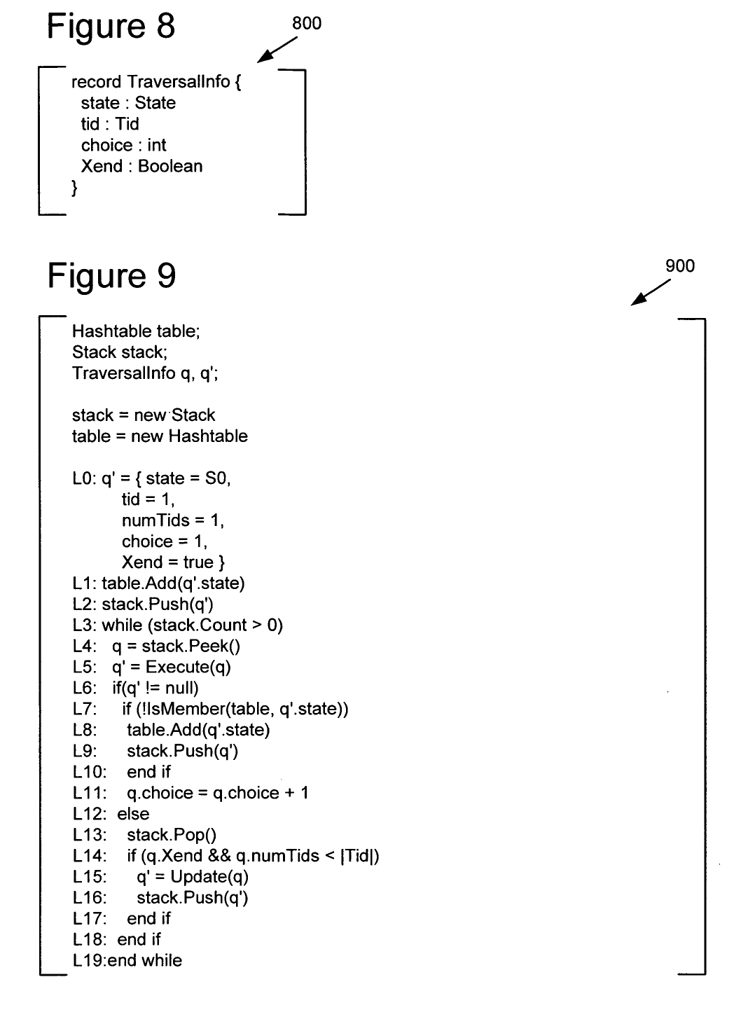

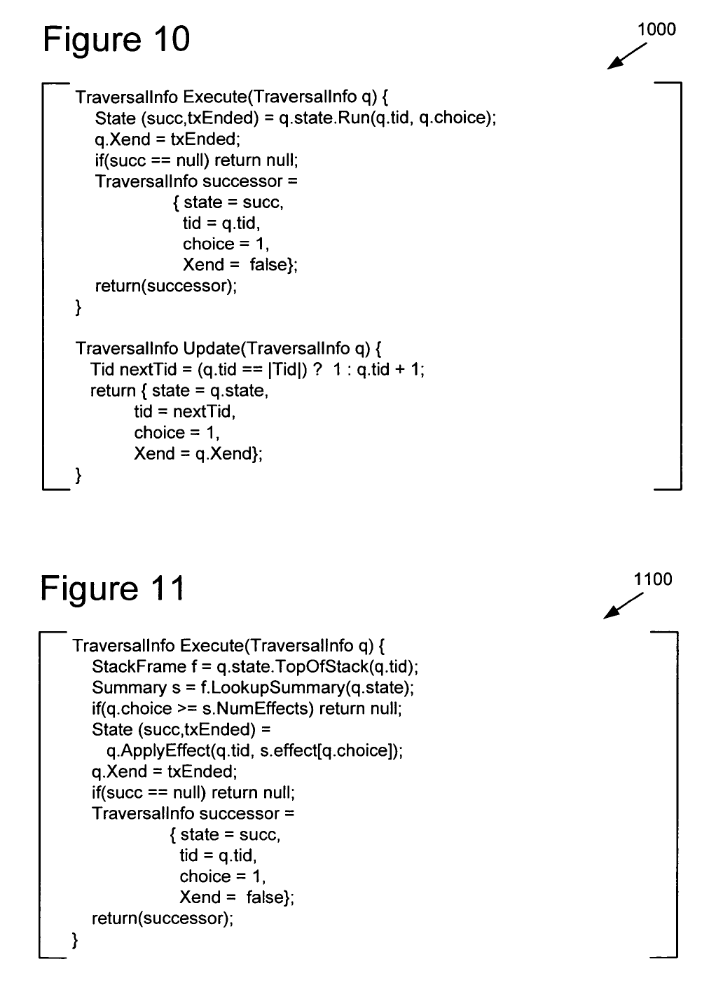

With reference to FIG. 8, each state in the DFS stack is encapsulated using a “TraversalInfo” record, as shown in code listing 800. In addition to the state, “TraversalInfo” records: (1) “tid”: the ID of the thread used to reach the state; (2) “choice”: the current index among the nondeterministic choices executable by thread “tid” in this state; and (3) “Xend”: denoting end-of-transaction, a Boolean which is set to true if and only if the model checker decides that all threads need to be scheduled in this state. A simplified presentation of the DFS algorithm is given in the code listing 900 in FIG. 9. For simplicity, let us assume that the total number of threads is given by |Tid|. (In the implementation described in this detailed example, the total number of threads can vary with time due to dynamic thread creation.) Two helper functions used by the algorithm are given in the code listing 1000 in FIG. 10. The algorithm schedules only a single thread as long as the thread is in the middle of a transaction. The “Execute” method works by running the thread “q.tid” with the non-deterministic choice “q.choice” for one atomic step with the “Run” method. The “Run” method returns a pair consisting of a new state and a Boolean that says whether the currently executing transaction ended. In line L14 of the top-level algorithm 900 in FIG. 9, a check is made to determine whether the current “TraversalInfo” is one where a transaction has ended, and if so, loop through all the threads and schedule each one of them using the “Update” method.

For more information on transaction-based reduction, see Qadeer et al., “Summarizing Procedures in Concurrent Programs,” POPL '04: ACMSIGPLAN-SIGACT Symposium on Principles of Programming Languages, pp. 245-55, Venice, Italy (January 2004).

Summarization is implemented entirely inside the “Execute” helper method shown in code listing 1100 in FIG. 11. Whenever the need arises to execute a step inside a transaction, instead of calling the “Run” method of the state, we instead look up a summary with possible effects using the “LookupSummary” method (as indicated in FIG. 11), apply the effect at index “q.choice” using the “ApplyEffect” method (as indicated in FIG. 11), and return a new “TraversalInfo” with the new state. The “ApplyEffect” method applies an effect on a state, as specified by the algorithm 700 described above in Section II.D with reference to FIG. 7.

“LookupSummary” is a static member of “StackFrame,” which represents a procedure activation record. The summaries for each procedure are thus stored as static members of the class representing the stack frames at method activations. Each summary contains a pattern and an array of effects, whose size is given by the “NumEffects” property.

The “LookupSummary” method searches for a summary with a matching pattern corresponding to the current state. If it finds a summary, it returns it. Otherwise, it starts an auxiliary search to compute such a summary. In this exemplary implementation, the ZING runtime library and the compiler-generated ZING object model are instrumented, so as to monitor all reads and writes during this auxiliary search. The runtime library is also modified so as to notify function call and function return events to the auxiliary search, in order to implement rules described above in Section II.D. When the auxiliary search terminates, the data captured from the instrumented reads and writes are converted to pattern and effects, and a new summary is generated.

This example implementation was difficult to implement, due to attempting to handle the whole of the ZING language with unrestricted references and unrestricted concurrency. In order to find and fix bugs and ensure correctness of the implementation, the ZING model checker was systematically compared with and without summarization on over 60 regression tests, several of which use both the heap and concurrent threads. A translator from Boolean programs to ZING was built, and the summarization algorithm produced identical results as BEBOP (a symbolic model checker for Boolean programs) in these examples.

For more information on the BEBOP symbolic model checker for Boolean programs, see Ball et al., “Bebop: A Symbolic Model Checker for Boolean Programs,” SPIN 00: SPIN Workshop, pp. 113-130 (2000).

F. Experiments

In this section, we describe four sets of experiments that we designed to measure the effectiveness of summarization. The first two experiments were designed to measure the performance gain due to summarization, and the next two were designed to assess the correctness and robustness of the implementation.

Transaction Manager: A concurrent transaction management program was automatically translated to ZING from C#. It has about 7000 lines of code, several dynamically created objects and two concurrent threads.

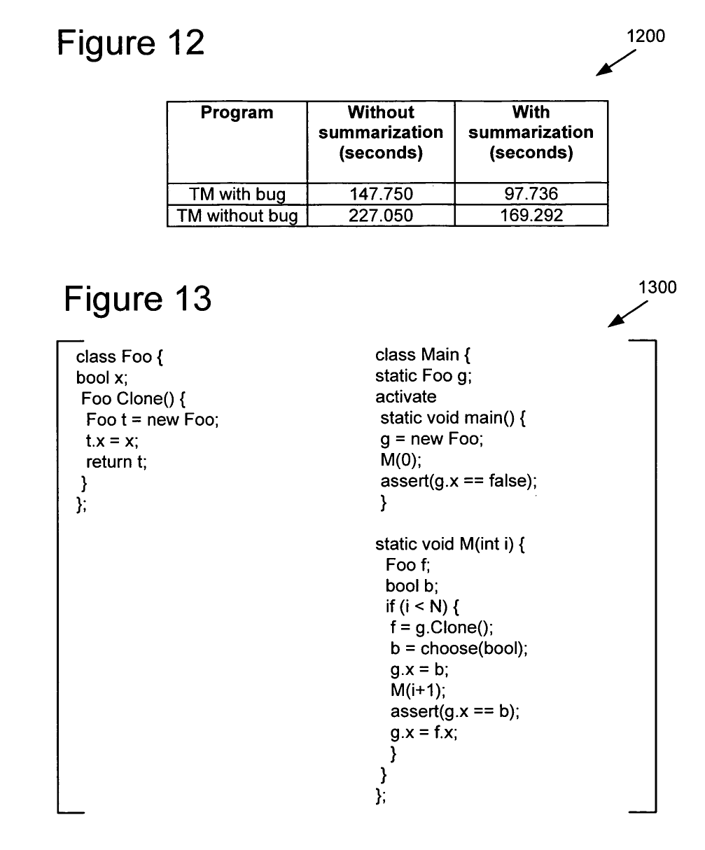

A “grep” utility was run on the program and showed 57 places in the code where new objects are allocated dynamically. Several of these happen in procedures that are called in several call-sites in the program. The ZING model checker discovered a null-pointer dereference bug in this program. A proposed fix was checked to determine that the fix did not have null-pointer dereferences. Both the models have several millions of reachable states. The error happens only in a particular, rarely exercised interleaving between the two threads, and had thus remained undetected in previous testing. Table 1200 in FIG. 12 shows the total time taken for model checking with and without summarization. The transaction management program has recursive data types, but does not have procedural recursion. Thus, it falls outside the class of programs on which our algorithm is guaranteed to terminate. However, it only creates bounded chains of objects and our model checker ends up terminating on this example with and without summarization. In both the buggy program and the bug-fixed program, the model checking time improved by the order of 30%-35% due to summarization.

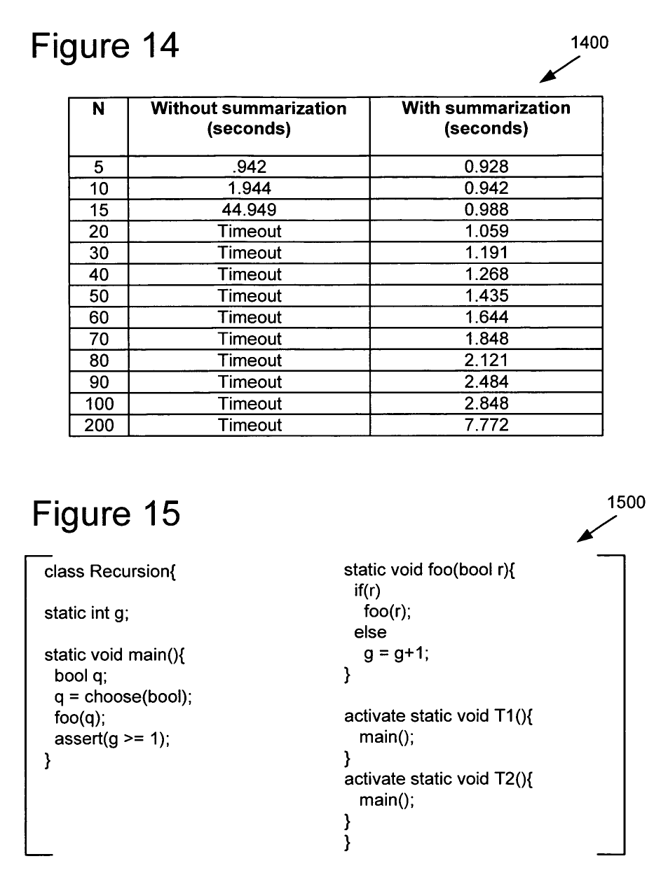

Micro-benchmark: Consider the benchmark program shown in code listing 1300 in FIG. 13. The function “M” makes two recursive calls to “M” due to the non-deterministic assignment “b=choose(bool).” Thus, as N varies, a naive model checker analyzing this program needs to make 2^{N} calls to “M.” However, if we use the example summarization algorithm, only 2N summaries for “M” are needed since only values that influence the behavior of “M” are its argument “i” which can take N different values, and the value of “g.x” which can be either true or false. Thus, a model checker using summarization can scale linearly with N on this program. Note that inside each recursive call, a fresh allocation to local variable “f” is done, and the algorithm is able to handle this case. The empirical results presented in table 1400 of FIG. 14 show exponential blowup in the model checker without summarization, and linear scaling with summarization. (“Timeout” indicates that the run did not terminate within 10 minutes.)

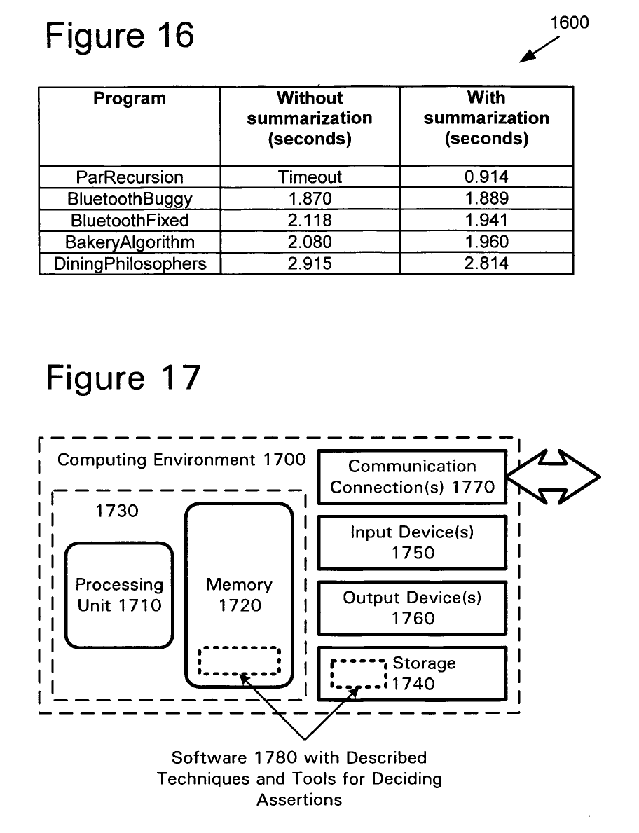

ZING Regressions: All the programs in the ZING regression suite were tested, with and without summarization. This suite contained 67 tests as of the time of testing). One of the tests is a recursive program 1500 shown in FIG. 15. In this example (labeled “ParRecursion” in table 1600 in FIG. 16), the model checker without summarization enters an infinite loop, but the model checker with summarization terminates. The other tests all run within a few seconds, and the improvements due to summarization are not noticeable. Table 1600 shows representative numbers for four of these tests: buggy and fixed versions of a Bluetooth device driver (“BluetoothBuggy,” “BluetoothFixed”), an implementation of Lamport's bakery algorithm (“BakeryAlgorithm”), and a model of Dijkstra's dining philosophers (“DiningPhilosophers”). The model checker with the summarization algorithm produces identical results (pass or fail) as the model checker without summarization on all the tests, showing that the implementation is working correctly.

SLAM Regressions: The SLAM toolkit was adapted to use ZING as the back-end model checker for Boolean programs instead of SLAM's model checker, BEBOP. (For more information on the SLAM project, see Ball et al., “The SLAM Project: Debugging System Software Via Static Analysis,” POPL 02: ACM SIGPLAN-SIGACT Symposium on Principles of Programming Languages, pp. 1-3 (January 2002)). This is a somewhat restricted use of ZING since Boolean programs have only Boolean variables and do not have any reference types. However, the summarization algorithm presented in this detailed example should produce identical results to BEBOP's summarization algorithm, when restricted to Boolean programs. This was checked on 198 of the 204 positive tests in the SLAM regression suite. Both BEBOP and ZING processed each of these tests in a second or less and produced identical results.

Summary of Experiments: In summary, summarization outperforms the naive model checker if the same procedure is called with the same context a large number of times, as expected. This was demonstrated both using the artificial program in FIG. 13 as well as the transaction management program. Extensive testing of this exemplary implementation has been done with almost all the regression tests from ZING and SLAM regression suites available at the time of testing. With a few exceptions, the algorithm produces identical results to a naive model checker, showing that the implementation is working correctly.

G. Comparisons

Interprocedural analyses based on context-free reachability have recently been used in of error-detection tools such as SLAM and ESP. See Ball et al., “The SLAM Project: Debugging System Software Via Static Analysis,” POPL 02: ACM SIGPLAN-SIGACT Symposium on Principles of Programming Languages, pp. 1-3 (January 2002); Das et al., “ESP: Path-sensitive Program Verification in Polynomial Time,” PLDI '02: Programming Language Design and Implementation, pp. 57-69, Berlin (June 2002); Reps et al., “Precise Interprocedural Dataflow Analysis Via Graph Reachability,” POPL '95: ACM SIGPLAN-SIGACT Symposium on Principles of Programming Languages, San Francisco (January 1995). SLAM uses an alias analysis to first conservatively abstract a C program to a Boolean program (a program without pointers), and ESP uses value-flow analysis and bit-vectorization to conservatively partition the analysis problem into separate problems, one each per distinct value. Imprecision in alias analysis and value flow analysis can lead to false errors in both approaches. In the case of SLAM some of these false errors can be eliminated using abstraction-refinement, where some extra predicates are added to keep track of specific aliasing relationships more precisely. The treatment of pointers in this detailed example from both these approaches. For models with non-recursive data types and finite base types, assertions can be decided inter-procedurally without losing any precision.

In the model checking community, researchers have started building model checkers that operate over concurrent heap-manipulating programs written in common programming languages such as Java. See DeMartini et al., “dSPIN: A Dynamic Extension of SPIN,” SPIN 99: SPIN Workshop, pp. 261-276, Toulouse, France (September 1999); Robby et al., Bogor: An Extensible and Highly Modular Software Model Checking Framework,” ESEC/FSE 03: Foundations of Software Eng'g, pp. 267-276, Helsinki (September 2003); Brat et al., “Java PathFinder: Second Generation of a Java Model Checker,” Proc. Post-CA V Workshop on Advances in Verification (July 2000). None of these model checkers exploit the procedural structure of the program for efficiency in model checking. The model checker BEBOP from the SLAM project was the first to exploit this idea in the simpler setting of Boolean program models. This work is a generalization of this idea to handle models with pointers. Though termination is guaranteed only when reference types are non-recursive, base-types are finite domain, and recursive procedures are “transactional,” we find that the implementation terminates on several cases and outperforms the model checker without summarization. A core result of this detailed example is a non-trivial synthesis of heap-canonicalization and transaction-based reduction from the model checking community, with summarization techniques from the program-analysis community.

It is also proposed to extend Boolean programs with references and extend BEBOP to handle these extended programs symbolically and that the assertion checking problem is decidable for this extension. The NEWTON tool in SLAM handles pointers by performing a mapping from caller-to-callee of the visible state on call, and back from callee-to-caller on return. It is proposed to extend BEBOP with a similar mapping semantics with references, and encode these mappings with extra Boolean variables, so that the symbolic BDD-based symbolic algorithm in BEBOP can handle the extended Boolean programs. Without a “new” operator in this extension, this extension would not have to deal explicitly with an unbounded number of addresses. Instead, the “address of” operator like the one in the C language could be used to initialize the references. This extension also would use a core idea of using visible state.

H. Conclusions

This detailed example describes an algorithm to perform precise interprocedural analysis of programs with references. The algorithm terminates on programs with finite base types and non-recursive reference types. Thus, it enables generating models with references as abstractions of large programs during model checking. This technique has been combined with other techniques to summarize procedures in concurrent programs, and the algorithm has been implemented for the whole of the ZING modeling language, which has both unrestricted reference types and unrestricted concurrency. The algorithm has been shown to improve the speed of a model checker by 30-35%.

The treatment of pointers described herein differs from earlier approaches. For models with non-recursive data types and finite base types, assertions can be decided inter-procedurally without losing precision. Though termination is guaranteed only when reference types are non-recursive, base types are finite-domain, and recursive procedures are “transactional,” the implementation described in this detailed example terminates on several cases and outperforms a model checker without summarization. This detailed example shows a non-trivial synthesis of heap-canonicalization and transaction-based reduction with summarization techniques.

III. Computing Environment

The techniques and tools described herein can be implemented on any of a variety of computing devices and environments, including computers of various form factors (personal, workstation, server, handheld, laptop, tablet, or other mobile), distributed computing networks, and Web services, as a few general examples. The techniques and tools can be implemented in hardware circuitry, as well as in software executing within a computer or other computing environment, such as shown in FIG. 17.

FIG. 17 illustrates a generalized example of a suitable computing environment 1700 in which described techniques and tools can be implemented. The computing environment 1700 is not intended to suggest any limitation as to scope of use or functionality of the invention, as the present invention may be implemented in diverse general-purpose or special-purpose computing environments.

With reference to FIG. 17, the computing environment 1700 includes at least one processing unit 1710 and memory 1720. In FIG. 17, this most basic configuration 1730 is included within a dashed line. The processing unit 1710 executes computer-executable instructions and may be a real or a virtual processor. In a multi-processing system, multiple processing units execute computer-executable instructions to increase processing power. The memory 1720 may be volatile memory (e.g., registers, cache, RAM), non-volatile memory (e.g., ROM, EEPROM, flash memory, etc.), or some combination of the two. The memory 1720 stores software 1780 implementing described techniques and tools for computer program testing.

A computing environment may have additional features. For example, the computing environment 1700 includes storage 1740, one or more input devices 1750, one or more output devices 1760, and one or more communication connections 1770. An interconnection mechanism (not shown) such as a bus, controller, or network interconnects the components of the computing environment 1700. Typically, operating system software (not shown) provides an operating environment for other software executing in the computing environment 1700, and coordinates activities of the components of the computing environment 1700.

The storage 1740 may be removable or non-removable, and includes magnetic disks, magnetic tapes or cassettes, CD-ROMs, CD-RWs, DVDs, or any other medium which can be used to store information and which can be accessed within the computing environment 1700. For example, the storage 1740 stores instructions for implementing software 1780.

The input device(s) 1750 may be a touch input device such as a keyboard, mouse, pen, or trackball, a voice input device, a scanning device, or another device that provides input to the computing environment 1700. The output device(s) 1760 may be a display, printer, speaker, CD-writer, or another device that provides output from the computing environment 1700.

The communication connection(s) 1770 enable communication over a communication medium to another computing entity. The communication medium conveys information such as computer-executable instructions, audio/video or other media information, or other data in a modulated data signal. By way of example, and not limitation, communication media include wired or wireless techniques implemented with an electrical, optical, RF, infrared, acoustic, or other carrier.

Techniques and tools described herein can be described in the general context of computer-readable media. Computer-readable media are any available media that can be accessed within a computing environment. By way of example, and not limitation, with the computing environment 1700, computer-readable media include memory 1720, storage 1740, communication media, and combinations of any of the above.

Some techniques and tools herein can be described in the general context of computer-executable instructions, such as those included in program modules, being executed in a computing environment on a target real or virtual processor. Generally, program modules include functions, programs, libraries, objects, classes, components, data structures, etc. that perform particular tasks or implement particular abstract data types. The functionality of the program modules may be combined or split between program modules as desired. Computer-executable instructions may be executed within a local or distributed computing environment.

Having described and illustrated the principles of our innovations in the detailed description and the accompanying drawings, it will be recognized that the various embodiments can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of embodiments shown in software may be implemented in hardware and vice versa.

In view of the many possible embodiments to which the principles of our invention may be applied, we claim as our invention all such embodiments as may come within the scope and spirit of the following claims and equivalents thereto.

We claim:

1. A method of generating a visible state summary for a procedure in a computer program, the method comprising:
determining a visible state of the computer program at invocation of the procedure; and
calculating an effect on the visible state, the effect caused by invocation of the procedure;
wherein a current stack frame is associated with the invocation of the procedure, and wherein the visible state comprises:
one or more variables; and
a set of heap addresses, each heap address in the set reachable from the one or more variables.

2. The method of claim 1 wherein the procedure is a recursive procedure.

3. The method of claim 1 wherein the one or more variables comprise at least one pointer.

4. The method of claim 1 wherein the one or more variables comprise at least one global variable.

5. The method of claim 1 wherein the one or more variables in comprise at least one local variable in the current stack frame.

6. The method of claim 1 wherein the one or more variables comprise at least one formal in the current stack frame.

7. A computer-readable medium having stored thereon computer-executable instructions for performing the method of claim 1.

8. A method of generating a summary for a procedure in a computer program, the method comprising:
determining a pattern of a visible state of the computer program at invocation of the procedure, wherein the pattern comprises a subset of the visible state observed by the procedure; and
calculating an effect on the pattern of the visible state, the effect caused by invocation of the procedure.

9. The method of claim 8 wherein the procedure is recursive.

10. The method of claim 8 wherein a current stack frame is associated with the invocation of the procedure, and wherein the visible state comprises:
all variables in the current stack frame; and
a set of heap addresses, each heap address in the set reachable from one or more of the variables in the current stack frame.

11. The method of claim 10 wherein the visible state further comprises one or more global variables, and wherein the subset of the visible state omits a global variable of the one or more global variables that is not observed by the procedure.

12. A computer-readable medium having stored thereon computer-executable instructions for performing the method of claim 8.

13. A method comprising:
generating a set of one or more summaries for a model of a source program, wherein the model comprises one or more non-recursive reference types, wherein the generating the set of one or more summaries comprises:
determining plural visible states for one or more procedures in the model;
determining equivalence or non-equivalence among the plural visible states based at least in part on an equivalence relation; and
determining one or more effects of a corresponding procedure one or more of the plural visible states; and
deciding an assertion in the model based at least in part on the set of one or more summaries for the model.

14. The method of claim 13 wherein at least one of the one or more procedures is recursive.

15. The method of claim 13 wherein the equivalence relation is as follows:
Two visible states [symbol] h₁, g₁, l₁ [symbol] and [symbol] h₂,g₂,l₂ [symbol] are equivalent if there exists a permutation ρ such that:
g₂(x)=ρ(g₁(x)) for all xεGlobal Var;
l₂(x)=ρ(l₁(x)) for all xεLocal Var;
h₂(ρ(a),f)=ρ(h₁(a,f)) for all aεCells( [symbol] A₁,g₁,l₁ [symbol] ) and fεField.

16. The method of claim 13 wherein the model further comprises a Boolean program.

17. The method of claim 13 wherein the method is performed in a model checker.

18. The method of claim 17 wherein the model checker includes functionality for checking models of concurrent programs.

19. The method of claim 13 wherein the source program is a concurrent program.

20. A computer-readable medium having stored thereon computer-executable instructions for performing the method of claim 8.
